(19) United States
(12) Patent Application Publication
(10) Pub. No.: US 2019/0318564 A1
(43) Pub. Date: Oct. 17, 2019

(54) COIN VALIDATION APPARATUS

(71) Applicant: FUJI ELECTRIC CO., LTD., Kawasaki-shi (JP)

(72) Inventors: Yoshito SHIBATA, Tsu-city (JP); Takeshi OOIWA, Ueda-city (JP); Masashi NAGATA, Yokkaichi-city (JP); Toshikazu NAKANISHI, Yokkaichi-city (JP); Kazuhiro TOMITA, Yokkaichi-city (JP)

(21) Appl. No.: 16/452,776

(22) Filed: Jun. 26, 2019

Related U.S. Application Data
(63) Continuation of application No. PCT/JP2017/046225, filed on Dec. 22, 2017.

(30) Foreign Application Priority Data
Mar. 16, 2017 (JP) 2017-051343

(51) Int. Cl. G07D 5/08; G07D 5/02; G07D 3/14

(52) U.S. Cl. CPC G07D 5/08; G07D 2205/0012; G07D 3/14; G07D 5/02

(57) ABSTRACT

A coin validation apparatus includes: a conveyor conveying a coin; and a discriminator discriminating authenticity and denomination of the coin, the conveyor including: conveyor pulleys, conveyor belts each endlessly stretched between the conveyor pulleys, conveying members, each having left and right end portions attached to outer surfaces of the conveyor belts, conveying the coin rearwards in a manner laid flat and convey a coin, which has been discriminated by the discriminator as a counterfeit coin, frontwards in a manner laid flat; and guide members, provided on sides of the conveyor belts, preventing the conveying members from being separated from the conveyor belts.

### CROSS-REFERENCE TO RELATED APPLICATIONS

This application is a continuation of PCT International Application No. PCT/JP2017/046225 filed on Dec. 22, 2017 which claims the benefit of priority from Japanese Patent Application No. 2017-051343 filed on Mar. 16, 2017, the entire contents of which are incorporated herein by reference.

### BACKGROUND

The present disclosure relates to a coin validation apparatus.

In the related art, as a coin validation apparatus that is used in a coin processing machine storing therein deposited coins by denomination, and dispensing the stored coins in response to a withdrawal (payment) instruction, a coin validation apparatus including a first conveyor, a discriminator, a rejector, and a second conveyor has been known.

The first conveyor includes a belt that is endlessly stretched across a pair of front and rear rollers. This first conveyor includes a belt on which deposited coins are placed, and conveys the coins in a direction from the front side to the rear side, as a result of the belt being displaced by the rotations of the rollers.

The discriminator is configured to discriminate (determine) the authenticity and the denomination of the coins that are being conveyed from the front side to the rear side by the first conveyor. The rejector removes the coin, which has been discriminated as a counterfeit coin by the discriminator, from the first conveyor by dropping the coin from the first conveyor.

The second conveyor includes a belt that is endlessly stretched across a pair of front and rear rollers, below the first conveyor. This second conveyor conveys the coin (counterfeit coin), which has been removed from the first conveyor by the rejector, to a predetermined storage destination, as a result of the belt being displaced by the rotations of the rollers.

In such a coin validation apparatus, the first conveyor conveys the deposited coins, and the discriminator discriminates the coins while the coins are being conveyed. The rejector then drops the coins, discriminated (determined) as counterfeit coins by the discriminator, from the first conveyor. In response, the second conveyor conveys the counterfeit coins to the storage destination (see Japanese Patent No. 5791674, for example).

With the coin validation apparatus disclosed in Japanese Patent No. 5791674 described above, because the second conveyor is installed below the first conveyor, the length of the apparatus in the front-back direction can be reduced. However, because the first conveyor and the second conveyor are driven by different driving sources, a mechanism for driving the first conveyor and a mechanism for driving the second conveyor have both been necessary. Such a requirement has resulted in an increase in the number of parts, and has led to an increased production cost.

### SUMMARY

There is need for providing a coin validation apparatus, the size of which is smaller and the cost of which can be reduced.

According to an embodiment, a coin validation apparatus includes: a conveyor conveying a coin; and a discriminator, provided above the conveyor, discriminating an authenticity and a denomination of the coin conveyed by the conveyor. Further, the conveyor includes: a pair of front and rear conveyor pulleys provided on front and rear sides of the coin validation apparatus, a pair of left and right conveyor belts each endlessly stretched between the pair of front and rear conveyor pulleys, a plurality of conveying members, each having left and right end portions attached to outer surfaces, facing upward, of the left and right conveyor belts, respectively, conveying the coin rearwards in a manner laid flat and convey a coin, which has been discriminated by the discriminator as a counterfeit coin, frontwards in a manner laid flat as the conveyor belts are moved. The coin validation apparatus further includes a pair of left and right guide members, provided on left and right sides of the left and right conveyor belts, respectively, preventing the conveying members from being separated from the conveyor belts.

According to an embodiment, a coin validation apparatus includes: a conveyor conveying a coin; and a discriminator, provided above the conveyor, discriminating an authenticity and a denomination of the coin conveyed by the conveyor. Further, the conveyor includes: a pair of front and rear conveyor pulleys provided on front and rear sides of the coin validation apparatus, a pair of left and right conveyor belts each endlessly stretched between the pair of front and rear conveyor pulleys, a plurality of conveying members, each having left and right end portions attached to outer surfaces, facing upward, of the left and right conveyor belts, respectively, conveying the coin rearwards in a manner laid flat and convey a coin, which has been discriminated by the discriminator as a counterfeit coin, frontwards in a manner laid flat as the conveyor belts are moved. The coin validation apparatus further includes a passage detector detecting a passage of the coin and each of the conveying members passing an area where the discriminator discriminates; and a controller to, upon receiving a command for stopping the conveyor belts, stop displacing the conveyor belts after the passage detector detects any of the conveying members.

### BRIEF DESCRIPTION OF THE DRAWINGS

FIG. 1 is a perspective view illustrating an internal structure of a coin processing machine using a coin validation apparatus according to an embodiment of the present disclosure;

FIG. 2 is a perspective view illustrating the coin validation apparatus of FIG. 1, that is, the coin validation apparatus according to the embodiment;

FIG. 3 is a perspective view illustrating the coin validation apparatus of FIG. 2, in which some elements thereof are removed;

FIG. 4 is a block diagram schematically illustrating a control system specific to the coin validation apparatus of FIGS. 2 and 3;

FIG. 5 is a top view illustrating a main portion of the coin validation apparatus of FIGS. 2 and 3;

FIG. 6 is a bottom view illustrating a main portion of the coin validation apparatus of FIGS. 2 and 3;

FIG. 7 is a perspective view illustrating a main portion of the coin validation apparatus of FIGS. 2 and 3;

FIG. 8 is an enlarged perspective view of an area where a conveying member is attached to conveyor belts;

FIG. 9 is an enlarged top view of the conveying member being displaced rearwards by the conveyor belts;

FIG. 10 is a perspective view illustrating a main portion of the coin validation apparatus of FIGS. 2 and 3;

FIG. 11 is an enlarged perspective view of a main portion of the coin validation apparatus of FIG. 10;

FIG. 12 is an exploded perspective view illustrating a main portion of the coin validation apparatus of FIGS. 2 and 3;

FIG. 13 is an enlarged view of a guide member and a structure around the guide member of FIG. 2;

FIG. 14 is a perspective view of a discriminator of FIGS. 2 and 3;

FIG. 15 is a vertical cross-sectional view of the discriminator of FIGS. 2 and 3;

FIG. 16 is a view illustrating a main portion of the discriminator when an upper main body of FIGS. 14 and 15 is swung in a closing direction of the upper main body;

FIG. 17 is another view illustrating a main portion of the discriminator when the upper main body of FIGS. 14 and 15 is swung in the closing direction of the upper main body;

FIG. 18 is another view illustrating a main portion of the discriminator when the upper main body of FIGS. 14 and 15 is swung in the closing direction of the upper main body;

FIG. 19 is a perspective view of the discriminator of FIGS. 2 and 3;

FIG. 20 is a bottom view of the upper main body of the discriminator of FIGS. 14 and 15; and

FIG. 21 is a flowchart illustrating details of a control process of stopping driving a conveyor executed by a controller of FIG. 4.

### DETAILED DESCRIPTION OF THE PREFERRED EMBODIMENTS

A coin validation apparatus according to a preferred embodiment of the present disclosure will now be explained in detail with reference to the accompanied drawings.

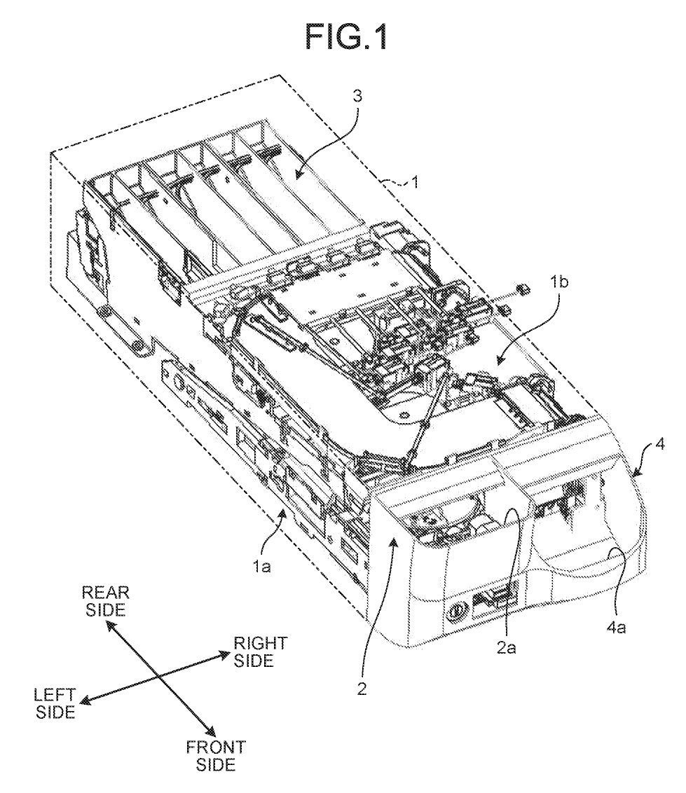

FIG. 1 is a perspective view illustrating an internal structure of a coin processing machine using the coin validation apparatus according to an embodiment of the present disclosure. This coin processing machine 1 described herein can be applied to, for example, a change dispenser, which stores therein deposited coins by denomination and dispenses the stored coins in response to a withdrawal (payment) instruction. Such a coin processing machine 1 includes a coin validation apparatus 1a and a coin conveyor apparatus 1b.

The coin validation apparatus 1a identifies the authenticity and the denomination of a coin deposited via a depositing device 2. The depositing device 2 includes a coin receptacle 2a as illustrated in FIG. 1, and is a part to which a coin is deposited. A structure of such a coin validation apparatus 1a will be described later.

The coin conveyor apparatus 1b conveys the coin, the authenticity and the denomination of which has been discriminated by the coin validation apparatus 1a (authentic coin), to identify the denomination of the coin being conveyed, to sort the coin by denomination and to deliver the sorted coin to a coin storage 3. The coin storage 3 is stores therein the coin in each denomination, the coin having been sorted by the coin conveyor apparatus 1b, and, when a withdrawal instruction is given, to deliver the coin, which corresponds to the withdrawal instruction, to a withdrawal device 4, and to dispense the coin outside via the withdrawal device 4.

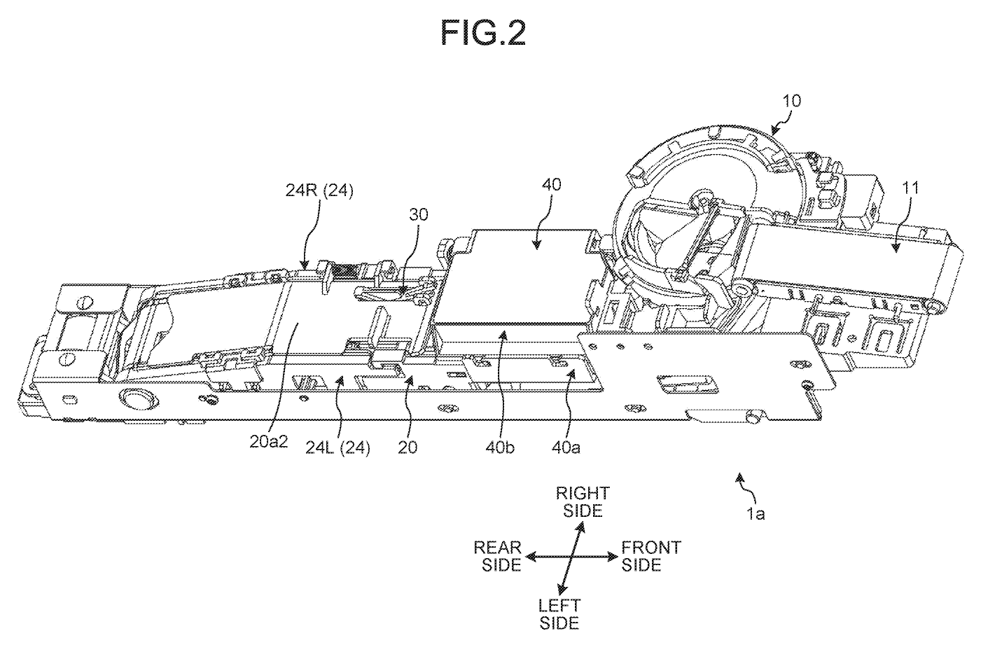

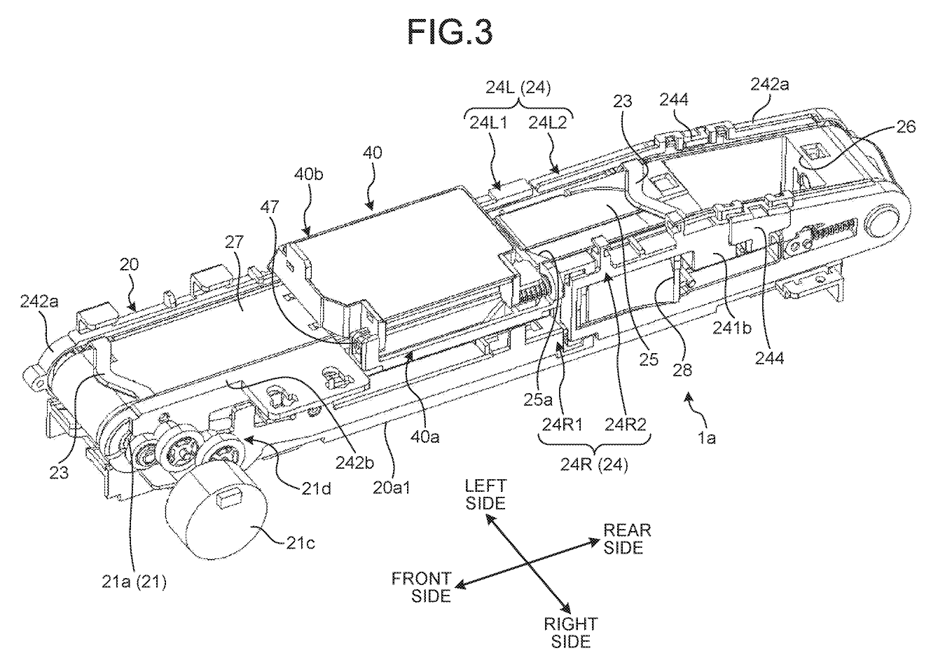

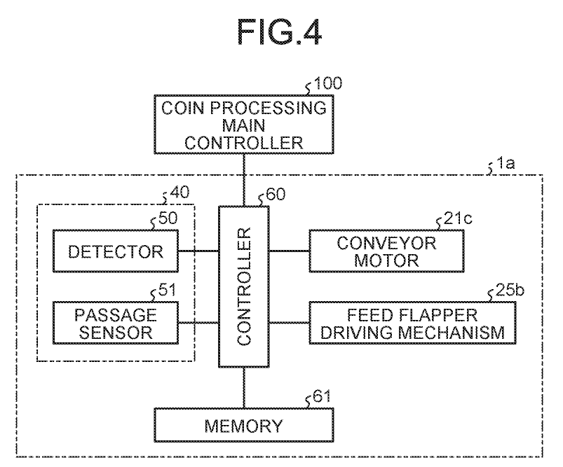

FIG. 2 is a perspective view illustrating the coin validation apparatus of FIG. 1, that is, the coin validation apparatus according to the embodiment. FIG. 3 is a perspective view illustrating the coin validation apparatus of FIG. 2, with some of its elements removed. FIG. 4 is a block diagram schematically illustrating a control system specific to the coin validation apparatus of FIGS. 2 and 3.

The coin validation apparatus 1a includes, as illustrated in FIGS. 2 to 4, a separator 10, a conveyor 20, a guiding member 30, a discriminator 40, and a controller (control unit) 60.

The separator 10 separates the coins one by one, the coins having been deposited via the depositing device 2 and conveyed by a deposit conveyor 11, and then deliver the coins, separated one by one, to the conveyor 20 one by one. The explanation of the separator 10 will be omitted herein, because the separator 10 is not an element specific to the present disclosure.

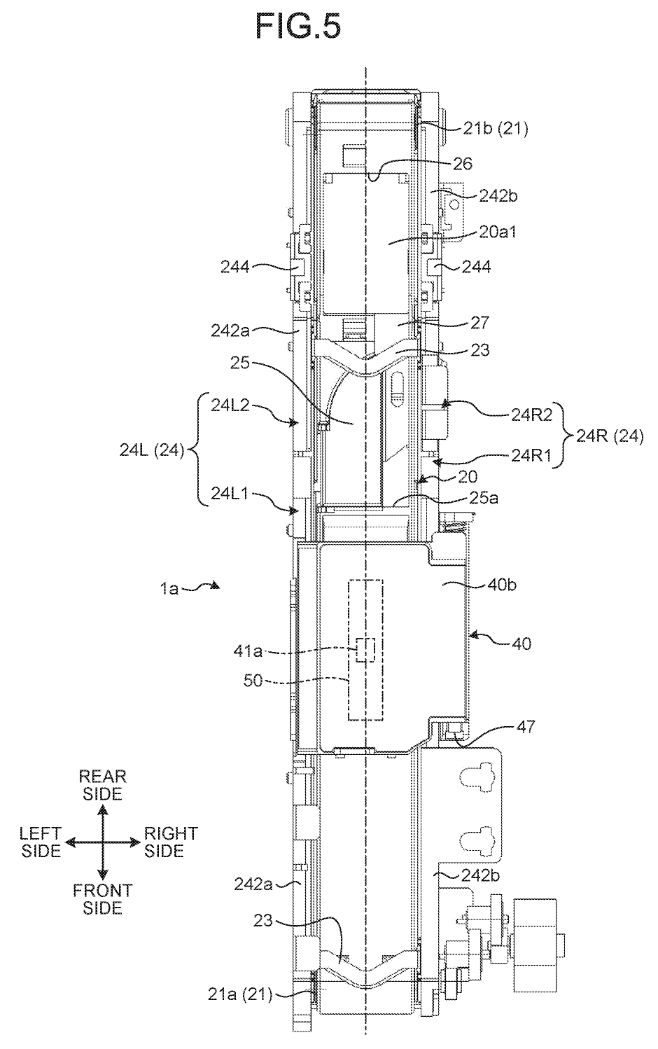

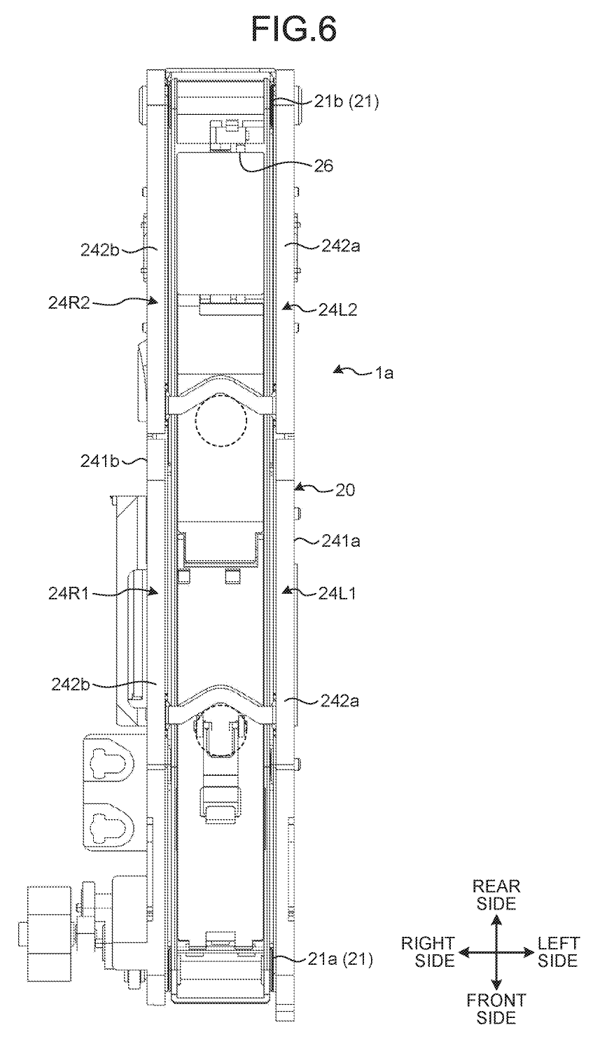

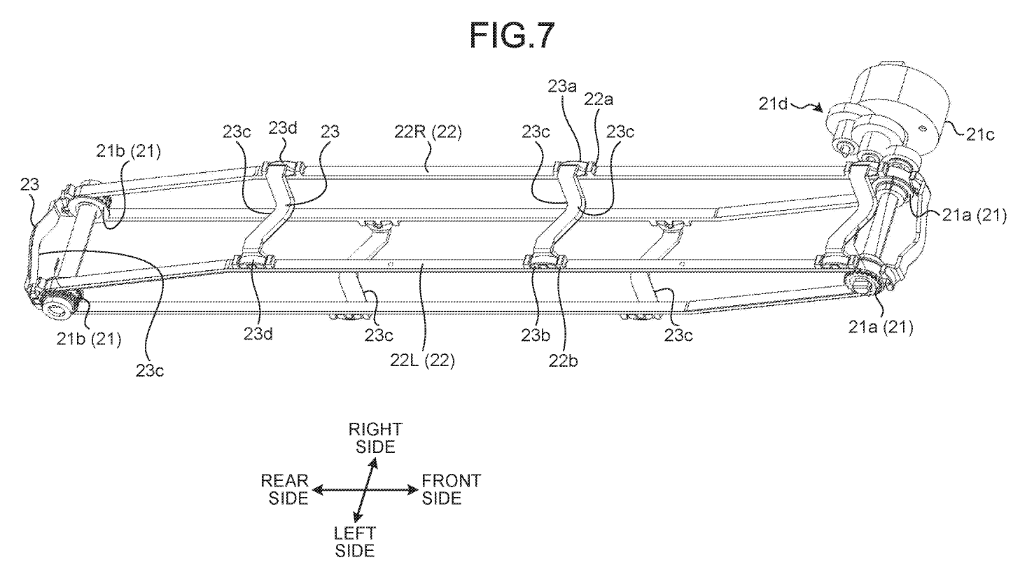

FIGS. 5 and 6 both illustrate a main portion of the coin validation apparatus 1a of FIGS. 2 and 3. FIG. 5 is a top view, and FIG. 6 is a bottom view. As illustrated in FIGS. 5 and 6, the conveyor 20 includes conveyor pulleys 21, conveyor belts 22 (see FIG. 7), conveying members 23, guide members 24, a feeding flapper 25, and a counterfeit coin opening 26.

The conveyor pulleys 21 are installed as a pair of front and rear pulleys, as also illustrated in FIG. 7. A front conveyor pulley 21a is linked with the output shaft of a conveyor motor 21c via a link gear unit 21d. This conveyor motor 21c starts driving upon receiving a drive command from the controller 60, and stops the driving upon receiving a driving stop command from the controller 60.

The front conveyor pulley 21a is a driving pulley that is caused to rotate about its central shaft as an axis, by being driven by the conveyor motor 21c. The front conveyor pulley 21a is rotated in the counterclockwise direction in a view from the left side, by receiving the driving force of the conveyor motor 21c.

The conveyor belts 22 include a left conveyor belt 22L and a right conveyor belt 22R provided as a pair of right and left conveyor belts. Each of these conveyor belts 22 (22L, 22R) is endlessly stretched between the conveyor pulleys 21. These conveyor belts 22 are displaced (moved) in the direction in which the conveyor belts 22 extend (i.e., in the extending direction of the conveyer belts 22), by the rotations of the front conveyor pulley 21a that is caused to rotate by being driven by the conveyor motor 21c. To explain more specifically, the conveyor belts 22 are displaced in such a manner that the upper section thereof is moved rearwards, and the lower section thereof is moved frontwards, by the rotations of the front conveyor pulley 21a.

The rear conveyor pulley 21b linked with the front conveyor pulley 21a via the conveyor belts 22 is rotated in the counterclockwise direction in a view from the left side, about its central shaft as an axis, by the rotations of the rear conveyor pulley 21b. In other words, the rear conveyor pulley 21b is a driven pulley that is driven by the rotations of the front conveyor pulley 21a.

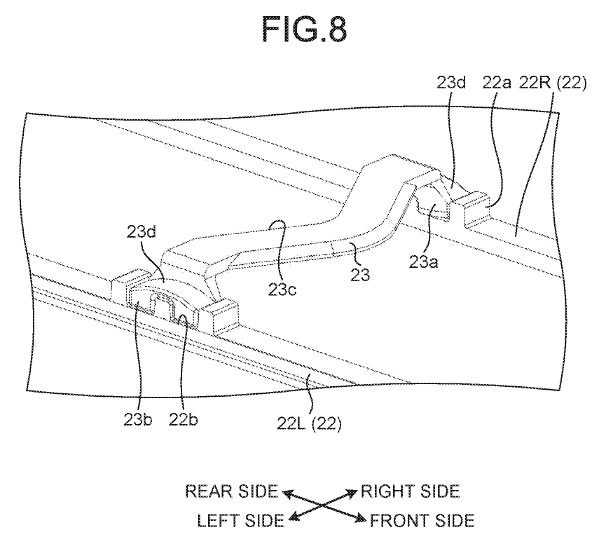

The conveying member 23 is provided in plurality, and the conveying members 23 are provided at an equal interval along the direction in which the conveyor belts 22 extend, in a manner straddling over (being bridged between) the pair of the right and left conveyor belts 22. To each of such conveying members 23, a right-end coupler 23a is provided to the right end, and a left-end coupler 23b is provided to the left end, as illustrated in, for example, FIG. 8. The right-end coupler 23a is then engaged with a right coupler 22a provided on an outer surface of the right conveyor belt 22R, and the left-end coupler 23b is engaged with a left coupler 22b provided on an outer surface of the left conveyor belt 22L. In this manner, the conveying member 23 is fixed to the pair of conveyor belts 22 in a manner straddling over the conveyor belts 22. With these engagements, the conveying members 23 are displaced as the conveyor belts 22 are displaced, in the direction in which the conveyor belts 22 extend.

The conveying members 23 are made of a light-shielding material so that the conveying members 23 can be detected by a passage sensor (optical sensor) 51, which will be described later. If the conveying members 23 are made of a translucent material, it is preferable for the translucent material to be colored.

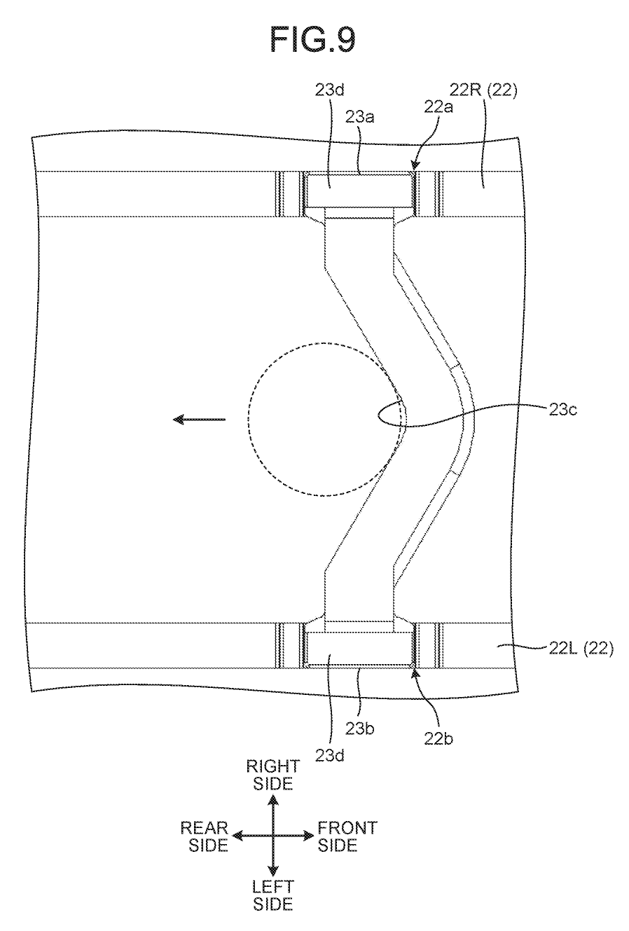

Such a conveying member 23 has a V-shaped surface as a surface 23c facing the downstream of the direction in which the conveyor belts 22 are to be displaced, that is, a surface facing rearwards on the upper section of the conveyor belts 22, and facing frontwards on the lower section of the conveyor belts 22. In other words, as illustrated in, for example, FIG. 9, the V-shape is formed on the surface 23c of the conveying member 23 facing the downstream in the direction in which the conveyor belts 22 are to be displaced, with the V-shape being formed by a surface extending to the left and another surface extending to the right in a manner inclined toward upstream in the direction in which the conveyor belts 22 are displaced, and meeting each other at the center of the surface 23c.

Each of the left and the right end of the conveying member 23 has a curved surface 23d. To explain more specifically, in the left end of the conveying member 23, the curved surface 23d having a convex shape protruding outwards is provided on an opposite surface of the surface having the left-end coupler 23b, that is, on the opposite surface of the surface that is in contact with the outer surface of the left conveyor belt 22L. In the right end of the conveying member 23, the curved surface 23d having a convex shape protruding outwards is provided on the opposite surface of the surface having the right-end coupler 23a, that is, on the opposite surface of the surface that is in contact with the outer surface of the right conveyor belt 22R.

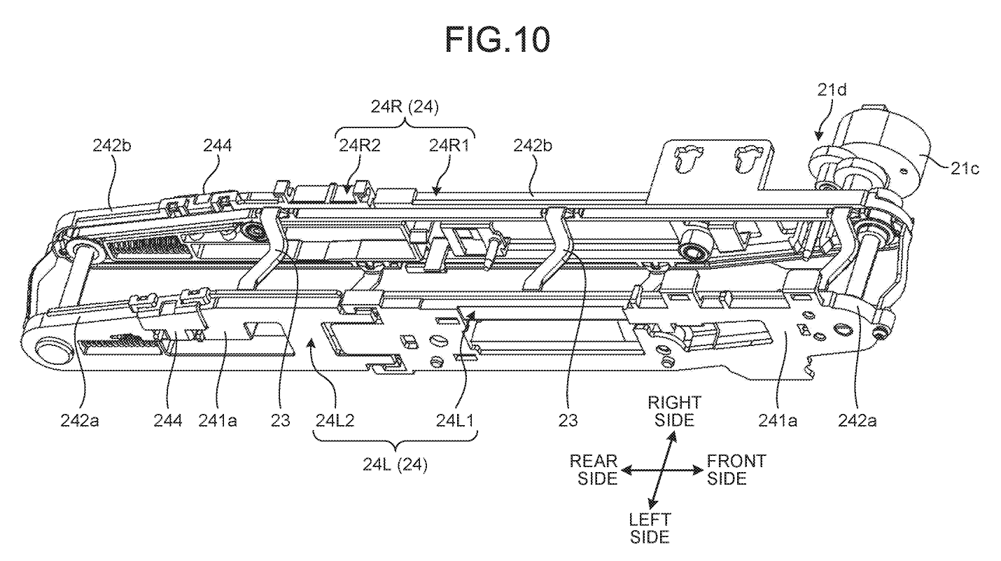

The guide members 24 are parts constituting a main body of the conveying apparatus, and include a left guide member 24L and a right guide member 24R, together forming a pair of right and left guide members, as illustrated in FIG. 10. The left guide member 24L includes a left front guide 24L1 and a left rear guide 24L2 that are coupled to each other. Such a left guide member 24L has a left guide base portion 241a and a left guide restricting portion 242a.

The left guide base portion 241a is positioned on the left side of the left conveyor belt 22L, and covers the left side of the left conveyor belt 22L. The left guide base portion 241a is provided with openings as appropriate. The left guide restricting portion 242a is provided integrally with the left guide base portion 241a, in a manner facing the outer surface of the left conveyor belt 22L. In other words, the left guide member 24L is provided in a manner surrounding the left conveyor belt 22L, with a part thereof facing the outer surface of the left conveyor belt 22L.

The left guide member 24L is provided in such a manner that the left guide base portion 241a restricts a detachment of the conveying members 23 from the conveyor belt 22 by moving leftwards with respect to the left conveyor belt 22L, and in such a manner that the left guide restricting portion 242a restricts a detachment of the conveying members 23 from the conveyor belt 22 by moving in any of upwards, downwards, frontwards, and rearwards with respect to the left conveyor belt 22L.

The right guide member 24R includes a front right guide 24R1 and a rear right guide 24R2 that are coupled to each other. Such a right guide member 24R has a right guide base portion 241b and a right guide restricting portion 242b.

The right guide base portion 241b is positioned on the right side of the right conveyor belt 22R, and covers the right side of the right conveyor belt 22R. The right guide base portion 241b may be provided with openings as appropriate. The right guide restricting portion 242b is provided integrally with the right guide base portion 241b, in a manner facing the outer surface of the right conveyor belt 22R. In other words, the right guide member 24R is provided in a manner surrounding the right conveyor belt 22R, with a part thereof facing the outer surface of the right conveyor belt 22R.

The right guide member 24R is provided in such a manner that the right guide base portion 241b restricts a detachment of the conveying members 23 from the conveyor belt 22 by moving rightwards with respect to the right conveyor belt 22R, and that the right guide restricting portion 242b restricts a detachment of the conveying members 23 from the conveyor belt 22 by moving in any of upwards, downwards, frontwards, and rearwards with respect to the right conveyor belt 22R.

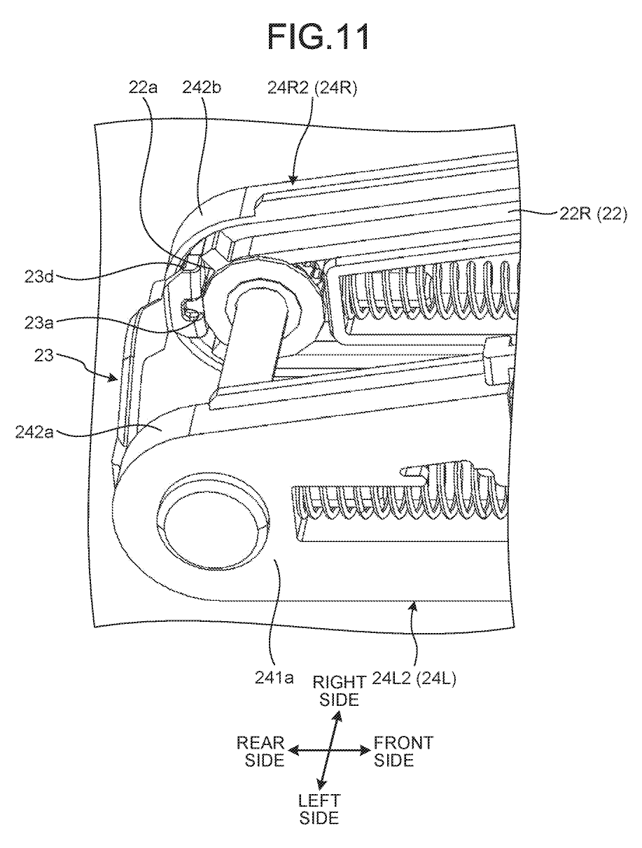

Because the guide restricting portion (the left guide restricting portion 242a and the right guide restricting portion 242b) of the guide member 24 (the left guide member 24L and the right guide member 24R) is provided in a manner facing the outer surface of the conveyor belt 22, the guide restricting portion have curved sections at positions facing the conveyor belt 22 along the outer circumferential portions of the conveyor pulleys 21. Because each of the right and the left ends of the conveying member 23 is provided with the curved surface 23d, when the conveying member 23 moves along the outer circumference of the conveyor pulley 21 as the conveyor belts 22 are displaced, as illustrated as enlarged in FIG. 11, the curved surface 23d is brought into sliding contact with the surface of the guide restricting portion 242a, 242b that faces the outer surface of the conveyor belt 22, with the coupler (the left coupler 22b and the right coupler 22a) coupled to the coupler (the left coupler 22b and the right coupler 22a) of the conveyor belt 22. In other words, the conveying member 23 can be moved as the conveyor belts 22 are displaced, while keeping the conveying member 23 coupled suitably to the conveyor belt 22.

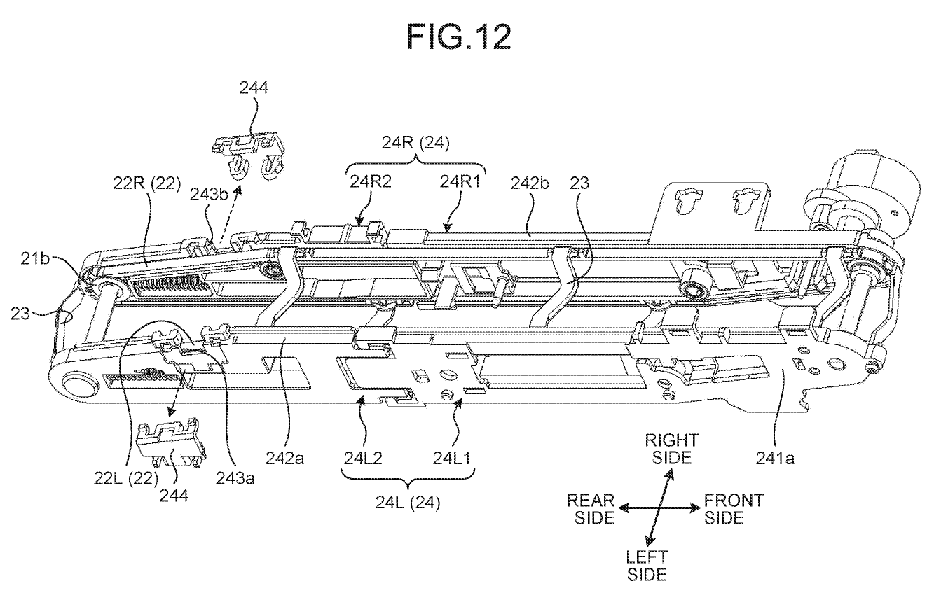

As illustrated in FIG. 12, a left cutout 243a and a right cutout 243b are provided to the respective guide members 24. The left cutout 243a is provided to the left rear guide 24L2. The right cutout 243b is provided to the rear right guide 24R2, in a manner paired with the left cutout 243a, as a pair of right and left cutouts. A part of the conveyor belt 22 is exposed via the left cutout 243a and the right cutout 243b, and the left cutout 243a and the right cutout 243b have a greater length in the front-back direction than that of the conveying member 23 in the front-back direction. In other words, the cutouts (the left cutout 243a and the right cutout 243b) have a size large enough for the conveying member 23 to pass therethrough, and are normally closed with closing members 244.

The cutouts (the left cutout 243a and the right cutout 243b) restricts a removal of the conveying member 23 from the conveyor belt 22 when the cutouts are closed with the closing members 244, and, enables the conveying member 23 to be removed from the conveyor belt 22 therethrough when the closing members 244 are removed and the cutouts are exposed.

As illustrated in FIGS. 3 and 5, the feeding flapper 25 is provided to a conveying base portion 27 that is provided between the conveyor belts 22, which forms a pair of right and left conveyor belts. To explain more specifically, the feeding flapper 25 is pivotally (swingably) provided to the left edge of an outlet 25a formed on the conveying base portion 27. The outlet 25a herein is an opening communicating with a delivery passage 28, and is enabled to deliver a coin passed therethrough to the coin conveyor apparatus 1b via the delivery passage 28.

The feeding flapper 25 is normally closed so that a passage of a coin through the outlet 25a is prohibited. The feeding flapper 25 exposes the outlet 25a by being swung in the direction in which the outlet 25a is exposed, by being driven by a feed flapper driving mechanism 25b. The feed flapper driving mechanism 25b starts driving so that the feeding flapper 25 is swung in the direction in which the feeding flapper 25 is open, in response to a drive command received from the controller 60, and stops driving, so that the outlet 25a is closed, in response to a driving stop command received from the controller 60.

The counterfeit coin opening 26 is a rectangular opening that is formed on the conveying base portion 27, behind the outlet 25a, as illustrated in FIGS. 3, 5, and 6. The counterfeit coin opening 26 has an enough size for a coin to pass therethrough. The coin passed through the counterfeit coin opening 26 is placed on a bottom section 20a1 that constitutes the main body of the conveying apparatus, together with the guide member 24.

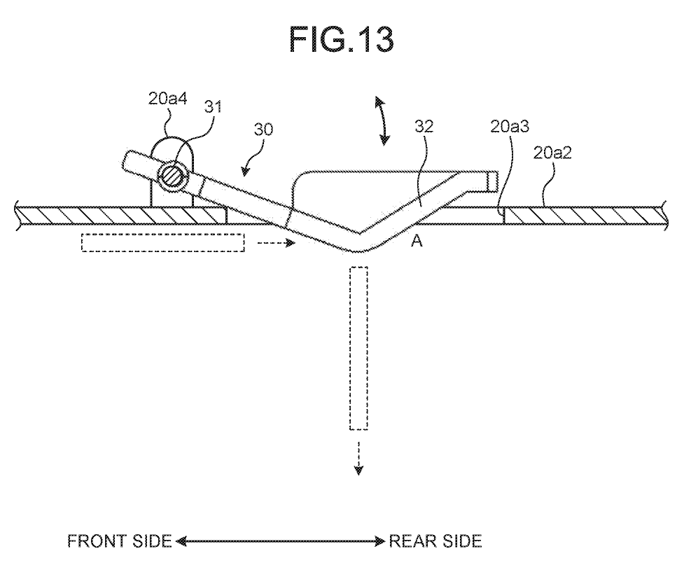

The guiding member 30 is provided above the outlet 25a of a top section 20a2 that constitutes the main body of the conveying apparatus, together with the guide member 24 and the bottom section 20a1, as illustrated in FIG. 2. As illustrated in FIG. 13, the guiding member 30 includes a guiding shaft 31 and a guiding actuator 32.

The guiding shaft 31 is a cylindrical member extending along the right and left direction. The guiding actuator 32 is a part extending outwards in the radial direction of the guiding shaft 31, more specifically, rearwards.

Such a guiding member 30 is swingably provided about the central axis of the guiding shaft 31, by hanging the guiding shaft 31 onto a guiding support piece 20a4 provided to the top section 20a2, in such a manner that the guiding actuator 32 is passed through a guiding opening 20a3 provided to the top section 20a2.

To explain more specifically, the guiding member 30 is swingably provided so that the bottom end of the guiding actuator 32 enters into and exits from a passage area A where a coin is passed by being conveyed rearwards by the conveyor 20, and is normally kept in an orientation in which the bottom end of the guiding actuator 32 sits inside the passage section A. When the outlet 25a is closed by the feeding flapper 25, the guiding member 30 is pushed by a coin passing through the passage section A, and is swung in a direction moving away from passage section A, so that the coin can be passed rearwards. By contrast, when the outlet 25a is exposed by the feeding flapper 25, the guiding member 30 is brought into contact with a coin being passed through the passage section A, and guides the coin into the outlet 25a.

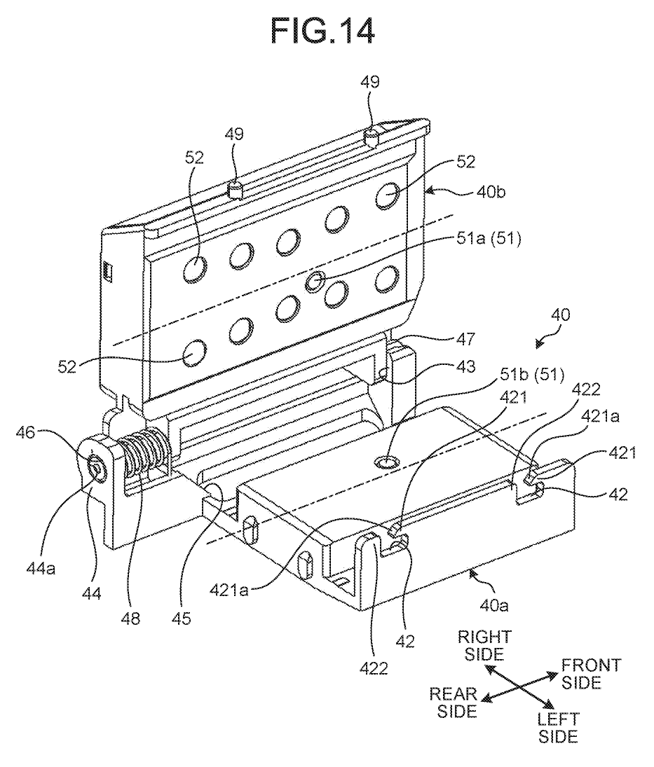

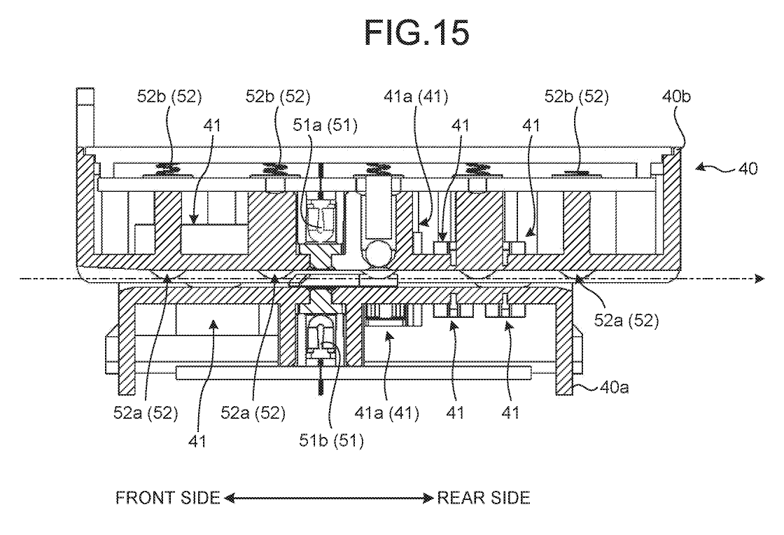

The discriminator 40 is installed, as illustrated in FIGS. 2, 3, and 5, at a position behind the separator 10 and in front of the outlet 25a. This discriminator 40 includes, as illustrated in FIGS. 14 and 15, a lower main body 40a and an upper main body 40b.

The lower main body 40a is provided below the upper sections of the conveyor belts 22 endlessly stretched between the conveyor pulleys 21. This lower main body 40a is a housing in which a plurality of magnetic sensors 41 are housed. The magnetic sensors 41 are arranged along the front-back direction, in a manner facing the center between the conveyor belts 22 (the center between the left conveyor belt 22L and the right conveyor belt 22; indicated as an example with a long dashed short dashed line in FIG. 14).

The lower main body 40a has stopper grooves 42, a shaft support groove 43, and a shaft support piece 44. There are two stopper grooves 42 provided in front and rear parts, respectively, on the left end of the lower main body 40a. A front top end 421 by which the stopper groove 42 is formed extends rearwards, and forms an opening with a rear top end 422. The top surface of the front top end 421 has a guiding surface 421a. The guiding surface 421a is a surface gradually curving downwards, as the guiding surface 421a is extended rearwards.

The shaft support groove 43 is provided to the front right end of the lower main body 40a. The shaft support piece 44 is provided to the rear right end of the lower main body 40a. The shaft support piece 44 has a shaft supporting hole 44a. A wiring through-hole 45 is provided to the right end of the lower main body 40a, between the shaft support groove 43 and the shaft support piece 44. The wiring through hole 45 is a hole through which the wiring for the upper main body 40b is passed.

The upper main body 40b is a housing in which a plurality of magnetic sensors 41 are housed, in the same manner as the lower main body 40a. The upper main body 40b is supported on the lower main body 40a, swingable about the central axis of a rear shaft-like portion 46 protruding rearwards and a front shaft-like portion 47 protruding frontwards, and both being provided to the right end of the upper main body 40b, by passing the rear shaft-like portion 46 through the shaft supporting hole 44a, and inserting the front shaft-like portion 47 into the shaft support groove 43.

A main body spring 48 is interposed between the upper main body 40b and the lower main body 40a. This main body spring 48 is installed in a manner wound around the rear shaft-like portion 46, and is a biasing unit for applying a biasing force to the upper main body 40b in a direction opening the upper main body 40b, that is, in a direction in which the upper main body 40b is swung upwards, and applying a frontward biasing force to the upper main body 40b along central axis of the rear shaft-like portion 46.

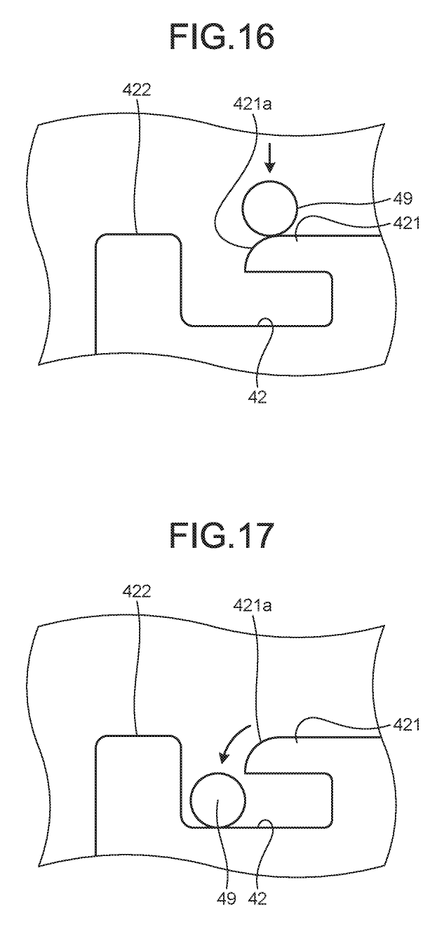

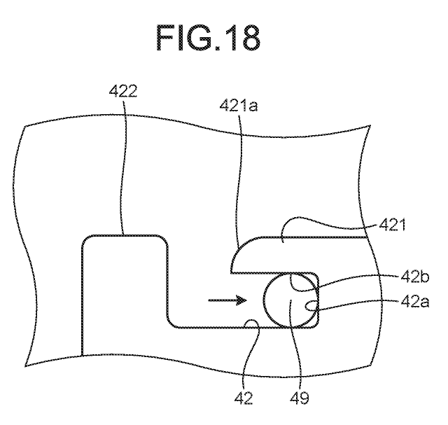

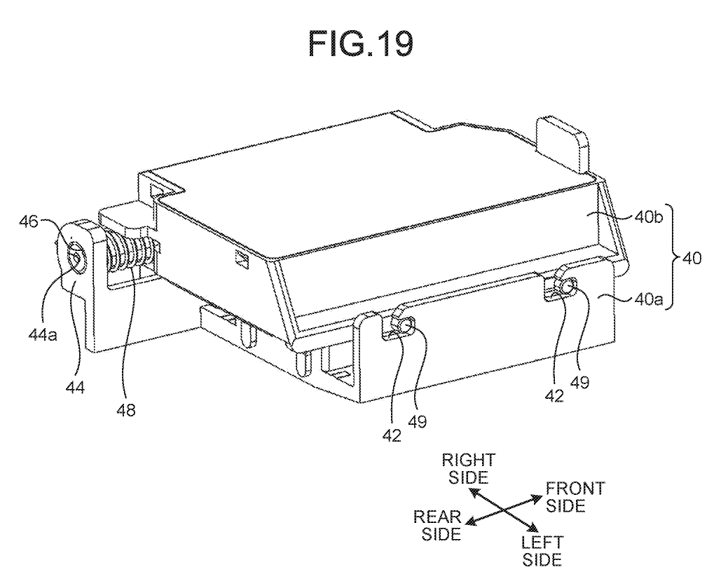

When such an upper main body 40b is swung in the direction in which the upper main body 40b is closed (downwards), against the biasing force of the main body spring 48, stopper protrusions 49 provided to the left end of the upper main body 40b are brought into abutment against the front top ends 421 of the respective stopper grooves 42, as illustrated in FIG. 16. Because the front top end 421 has the guiding surface 421a, as mentioned earlier, the stopper protrusion 49 slides along the guiding surface 421a as the upper main body 40b is swung, and then enter the stopper groove 42, as illustrated in FIG. 17. Because the upper main body 40b is applied with a frontward biasing force of the main body spring 48 with respect to the lower main body 40a, as mentioned earlier, the biasing force of the main body spring 48 brings each of the stopper protrusions 49 into abutment against a front end 42a of the corresponding stopper groove 42, and against a bottom end 42b of the corresponding front top end 421 (the top edge of the stopper groove 42), as illustrated in FIG. 18, and the upper main body 40b is hooked onto the lower main body 40a, as illustrated in FIG. 19.

With the upper main body 40b hooked onto the lower main body 40a in the manner described above, the upper main body 40b is positioned above the upper section of the conveyor belts 22 that are endlessly stretched between the conveyor pulley 21, and the magnetic sensors 41 housed inside form pairs with the counterpart magnetic sensors 41 housed inside of the lower main body 40a. In other words, when the upper main body 40b is hooked onto the lower main body 40a, with each of the stopper protrusions 49 abutting against the front end 42a of the corresponding stopper groove 42 and against the bottom end 42b of the corresponding front top end 421, the magnetic sensors 41 are aligned in a manner facing the center part between the conveyor belts 22 (the center part between the left conveyor belt 22L and the right conveyor belt 22) in the front-back direction, and are paired with the counterpart magnetic sensors 41 having the same detecting function, the pairs together forming a detector 50 (see FIGS. 4 and 5).

The detector 50 includes the magnetic sensors 41 in the lower main body 40a and the magnetic sensors 41 in the upper main body 40b, all of which are arranged in the front-back direction, in a manner facing the center part between the conveyor belts 22, and detects the characteristics of the coins being passed using the magnetic sensors 41. A magnetic sensor 41a for detecting a coin thickness is provided at the center part of the detector 50 in the front-back direction.

Such a discriminator 40 discriminates (determines) the authenticity and the denomination of a coin being conveyed rearwards by the conveyor 20 while the coin is passed through a predetermined discriminating area, by causing the detector 50 to detect the characteristics of the coin. The discriminator 40 then transmits the discrimination result to the controller 60, as a discrimination signal.

In addition to the elements described above, the discriminator 40 further includes a passage sensor 51 and a plurality of ball pushers (pressing members) 52. The passage sensor 51 is a sensor generally known as an optical sensor, and is a passage detector unit detecting a passage of a coin and the conveying members 23 across the predetermined discriminating area. When passage of a coin or a conveying member 23 is detected, the passage sensor 51 sends a passage signal to the controller 60. Such a passage sensor 51 includes a light emitter 51a provided to the upper main body 40b, and a light receiver 51b provided to the lower main body 40a, and is provided at a position offset from the center part between the conveyor belts 22.

The ball pushers 52 are provided to the upper main body 40b. Each of such ball pushers 52 constantly applies a downward biasing force to a ball (sphere) 52a made of a material harder than coins, e.g., ceramic, using a ball spring 52b, and to press down the coin passing through the discriminating area.

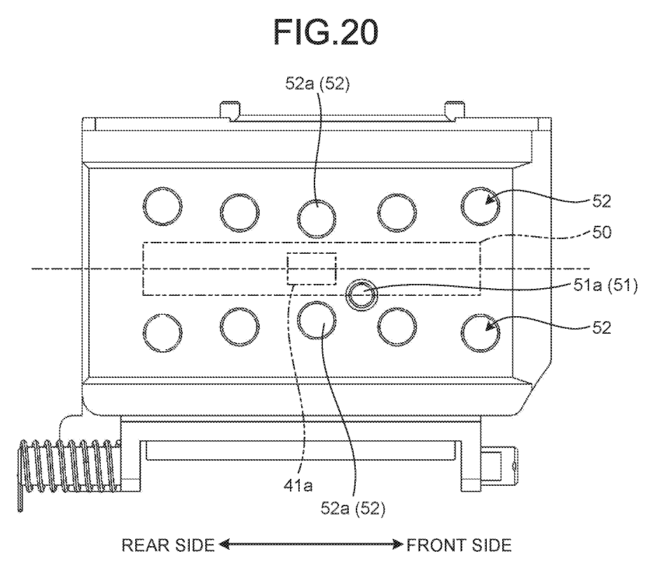

As illustrated in FIG. 20, these ball pushers 52 are installed along the front-back direction, as pairs of right and left ball pushers, with respect to the center between the conveyor belts 22 (the center being indicated with a long dashed short dashed line). To explain more specifically, the ball pushers 52 are installed in such a manner that the width between the right and left ball pushers gradually becomes narrower from the front side toward the magnetic sensor 41a detecting the coin thickness, and that the width between the left and the right ball pushers becomes wider toward the rear side with respect to the magnetic sensor 41.

The controller 60 controls the operations of the coin validation apparatus 1a comprehensively, in accordance with a computer program and data stored in a memory 61. Such a controller 60 may be implemented by causing a processor such as a Central Processing Unit (CPU) to execute a computer program, that is, as a piece of software, as a piece of hardware such as an Integrated Circuit (IC), or as a combination of pieces of software and hardware.

In the coin validation apparatus 1a having the configuration described above, a plurality of coins are deposited via the depositing device 2, and the controller 60 gives a drive command to the conveyor motor 21c in response to an operation instruction received from a coin processing main controller 100 controlling the operations of the coin processing machine 1 comprehensively.

In response, the conveyor motor 21c starts driving, and the conveyor 20 causes the conveyor belts 22 to become displaced in the direction in which the conveyor belts 22 extend, by driving the conveyor pulley 21 into rotation in the counterclockwise direction in a view from the left side. The coins deposited via the depositing device 2 are separated from one another by the separator 10, and is supplied to the conveyor 20, one coin at a time.

The coins supplied to the conveyor 20 are laid flat on the top surface of the conveying base portion 27. Because the conveyor belts 22 are being displaced in the direction in which the conveyor belts 22 extend, as described above, the conveying members 23 fixed to the conveyor belts 22 press the coins on the top surface of the conveying base portion 27 rearwards, so that the coins are carried rearwards.

Because the conveying member 23 has the V-shaped surface 23c facing downstream in the direction in which the conveyor belts 22 are displaced, the surface 23c facing downstream serves as a surface for pressing the coin as the conveyor belts 22 are displaced, as illustrated in FIG. 9. Therefore, the coins can be conveyed in a manner collected at the center part of the right and left direction.

When the coins are conveyed rearwards and reaches the discriminating area of the discriminator 40, by being pressed by the conveying member 23 in the manner described above, the discriminator 40 causes the passage sensor 51 to detect the passage of each of such coins, and causes the detector 50 to discriminate the authenticity and the denomination of the coin. This discriminator 40 sends the discrimination result to the controller 60 as a discrimination signal.

The controller 60 receives the discrimination signal from the discriminator 40. If the discrimination result indicates that the coin is an authentic coin, the controller 60 gives a drive command to the feed flapper driving mechanism 25b. This drive command causes the feed flapper driving mechanism 25b to drive, and causes the feeding flapper 25 to swing in the direction in which the feeding flapper 25 opens, so that the outlet 25a is exposed. Once the feeding flapper 25 exposes the outlet 25a in the manner described above, the coin having passed through the discriminating area, and being conveyed rearwards by being pressed by the conveying member 23 is brought into abutment against the guiding member 30 to have its orientation changed, passed through the outlet 25a, and is delivered to the coin conveyor apparatus 1b. After the coin discriminated as an authentic coin passes through the outlet 25a, the controller 60 transmits a driving stop command to the feed flapper driving mechanism 25b. This causes the feeding flapper 25 to close the outlet 25a.

When the controller 60 receives the discrimination signal from the discriminator 40, and the discrimination result indicates that the coin is a counterfeit coin, the controller 60 keeps the outlet 25a closed with the feeding flapper 25, without giving a drive command to the feed flapper driving mechanism 25b.

As a result of this operation, the coin having passed through the discriminating area and being conveyed rearwards by being pressed by the conveying member 23 is carried along the top surface of the feeding flapper 25, and passed and dropped through the counterfeit coin opening 26. The dropped coin is laid flat on the bottom section 20a1 of the main body of the conveying apparatus.

The lower sections of the conveyor belts 22 are being displaced frontwards by the rotations of the conveyor pulleys 21. Because the conveying members 23 fixed to the conveyor belts 22 are thus moved frontwards in the lower section of the conveyor 20, as illustrated in FIG. 6, the conveying members 23 can convey the coins by pressing the coins frontwards along the bottom section 20a1. At this time, because each of the conveying members 23 has the V-shaped surface 23c facing downstream in the direction in which the conveyor belts 22 are displaced, the conveying members 23 can convey the coin rearwards, in a manner collected at the center of the right and left direction.

In this manner, the conveyor 20 delivers the coin conveyed frontwards (counterfeit coins) to a dispenser not illustrated. The dispenser delivers the coins dispensed thereto to the withdrawal device 4, and to dispense the coins outside via a coin outlet 4a (see FIG. 1) provided to the withdrawal device 4.

When the controller 60 receives a stop command from the coin processing main controller 100, upon completion of the conveyance of the coin deposited via the depositing device 2, the controller 60 executes control for stopping driving the conveyor.

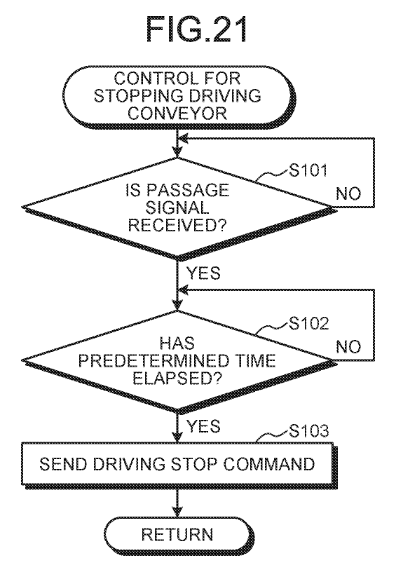

FIG. 21 is a flowchart illustrating the details of a control process for stopping driving the conveyor executed by the controller illustrated in FIG. 4.

In the control for stopping driving the conveyor, the controller 60 waits to receive a passage signal from the passage sensor 51 (Step S101). If the passage sensor 51 detects the passage of one of the conveying members 23, and the controller 60 receives the passage signal from the passage sensor 51 (Yes in Step S101), the controller 60 is kept standby for a predetermined time (Step S102). The predetermined time is time required for the conveying member 23 to move out of the detection area of the passage sensor 51, but in which no subsequent conveying member 23 arrives at the detection area.

If the predetermined time has elapsed (Yes in Step S102), the controller 60 sends a driving stop command to the conveyor motor 21c (Step S103), shifts the process to the beginning, and ends the current control for stopping driving the conveyor unit. As a result, the conveyor motor 21c stops driving the conveyor unit 20.

As explained above, the coin validation apparatus 1a discriminates the authenticity and the denomination of a coin deposited via the depositing device 2, and delivers the coin discriminated as an authentic coin to the coin conveyor apparatus 1b, and dispenses the coin discriminated as a counterfeit coin outside via the withdrawal device 4.

With such a coin validation apparatus 1a, the conveyor belts 22 included in the conveyor 20 are provided as a pair of right and left belts in a manner endlessly stretched between the conveyor pulleys 21 that are provided as a pair of front and rear conveyor pulleys. The conveying member 23, having its right and left ends attached to the outer surfaces of the conveyor belts 22, conveys the deposited coin rearwards, in a manner laid flat, and conveys the coin that is discriminated as a counterfeit coin by the discriminator 40 frontwards, in a manner laid flat, as the conveyor belts 22 are displaced. Therefore, the length of the conveyor 20 in the front-back direction can be reduced. Moreover, because it is not necessary to provide separate conveyors for conveying the deposited coins and for conveying the coins discriminated as counterfeit coins by the discriminator, as have been required in the related art, the number of components can be reduced, so that it is possible to reduce the size of the entire apparatus as well as the production cost.

Particularly, the guide member 24 provided in a manner surrounding the conveyor belts 22, with a part thereof facing the outer surface of the conveyor belt 22, restricts detachment of the conveying members 23 from the conveyor belt 22, the conveying member 23 is allowed to convey coins suitably.

Furthermore, when the cutouts (the left cutout 243a and the right cutout 243b) provided to the guide member 24 are exposed, the conveying member 23 can be removed from the conveyor belt 22 via the cutouts, and when the cutouts are closed with the closing members 244, the closing members 244 restrict the removal of the conveying member 23 from the conveyor belts 22 via the cutouts. Therefore, when the cutouts are exposed, the conveying member 23 can be replaced via the cutouts. In other words, if any of the conveying members 23 is broken, for example, the conveying member 23 can be replaced easily by removing the closing members 244 and exposing the cutouts, without disassembling the apparatus itself.

In the coin validation apparatus 1a described above, because the conveying member 23 included in the conveyor 20 has the V-shape on the surface pressing coins, as the conveyor belts 22 are displaced, the conveying member 23 can convey the coin in a manner collected at the center part of the right and left direction. Therefore, by limiting the positions where the coins are conveyed, the coins can be conveyed stably, and the accuracy of discrimination performed by the discriminator 40 can be improved.

In the coin validation apparatus 1a described above, when the controller 60 receives a stop command from the coin processing main controller 100, the controller 60 stops displacing the conveyor belt 22 after a predetermined time elapses from when the passage sensor 51 has detected the passage of one of the conveying members 23. Therefore, it is possible to prevent any of the conveying members 23 from remaining in the detection area of the passage sensor 51. In this manner, when the coin deposited subsequently is conveyed, the passage sensor 51 can be prevented from making a misdetection that the conveying member 23 inside the detection area is a coin.

In the coin validation apparatus 1a described above, the ball pushers 52 included in the discriminator 40 and pressing down the coins being conveyed rearwards by the conveying members 23 are installed along the front-back direction, as pairs of right and left ball pushers with reference to the center part between the conveyor belts 22, and are installed in such a manner that the width between the left and the right ball pushers gradually becomes narrower from the front side toward the magnetic sensor 41 detecting the coin thickness. Therefore, the coins conveyed by the conveying members 23 can be collected reliably to the center part between the conveyor belts 22, so that the accuracy of the detection of the detector 50 can be improved, and therefore, an improved accuracy of discrimination performed by the discriminator 40 can also be ensured.

Moreover, because the ball pushers 52 are installed in such a manner that the width between the left and the right ball pushers gradually becomes wider toward the rear side from the magnetic sensor 41 detecting the thickness, the pressing force applied to the coin having passed through the magnetic sensor 41 can be released gradually, and be conveyed in a manner following the shape of the conveying members 23, so that the coins can be guided to the outlet 25a that is positioned offset to the right with respect to the center between the conveyor belts 22.

Furthermore, because the ball pushers 52 are installed at varying widths between the left and the right ball pushers, the pressing force of the ball pushers 52 is not applied only onto the specific portions of the conveying members 23 for conveying coins. Therefore, damages or the like of the conveying members 23 can be suppressed.

In the coin validation apparatus 1a described above, because the front top end 421 of the stopper groove 42 provided to the lower main body 40a has the guiding surface 421a, and is biased by the main body spring 48 in a direction in which the upper main body 40b is open and also in a frontward direction along the central shaft of the rear shaft-like portion 46, merely by swinging the upper main body 40b in the direction in which the upper main body 40b is closed, the stopper protrusion 49 is caused to slide along the guiding surface 421a, and to enter the stopper groove 42, and the stopper protrusion 49 having entered the stopper groove 42 is brought into abutment against the front end 42a of the stopper groove 42 and the bottom end 42b of the front top end 421. Therefore, the upper main body 40b can be hooked onto the lower main body 40a, with the magnetic sensors 41 in the upper main body 40b paired with counterpart magnetic sensors 41 in the lower main body. In other words, the magnetic sensor 41 can be aligned simply by swinging the upper main body 40b in the direction in which the upper main body 40b is closed.

A preferred embodiment of the present disclosure is explained above, but the present disclosure is not limited thereto, and various modifications may still be possible.

In the embodiment described above, the ball pushers 52 are installed in such a manner that the width between the left and the right ball pushers gradually becomes wider toward the rear side, from the magnetic sensor 41 detecting the thickness. However, according to the present disclosure, as long as the pressing members are installed in such a manner that width between the left and the right ball pushers gradually becomes narrower from the front side toward the center of the front-back direction of the detector, subsequent pressing members may be arranged in any way.

According to the present disclosure, because the conveyor belts included as a pair of right and left conveyor belts in the conveyor are endlessly stretched between the conveyor pulleys that are provided as a pair of front and rear conveyor pulleys, and because the conveying member that has a left end and a right end attached to outer surfaces of the conveyor belts conveys a deposited coin rearwards, in a manner laid flat, and conveys a coin discriminated as a counterfeit coin by the discriminator frontwards, in a manner laid flat, as the conveyor belts are displaced, the length of the conveyor in the front-back direction can be reduced. Moreover, because it is not necessary to provide a conveyor for conveying a deposited coin and another conveyor for conveying a coin discriminated as a counterfeit coin by the discriminator, as having been required in the related art, the number of parts can be reduced. Hence, the size of the entire apparatus as well as the production cost can be reduced.

Particularly, because the guide member provided in a manner partially surrounding the conveyor belt, with a part thereof facing the outer surface of the conveyor belts restricts a detachment of the conveying member from the conveyor belts, the conveying member is enabled to convey a coin suitably.

Furthermore, because, when the control unit receives a command for stopping the conveyor belts, the control unit stops displacing the conveyor belts after the passage detector unit has detected one of the conveying members, it can be ensured that no conveying member is inside the detection area of the passage detector unit. In this manner, when a coin deposited subsequently is conveyed, the passage detector unit can be prevented from making a misdetection that the conveying member inside the detection area is a coin, advantageously.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A coin validation apparatus comprising:
a conveyor configured to convey a coin; and
a discriminator, provided above the conveyor, configured to discriminate an authenticity and a denomination of the coin conveyed by the conveyor, wherein
the conveyor includes:
a pair of front and rear conveyor pulleys provided on front and rear sides of the coin validation apparatus,
a pair of left and right conveyor belts each endlessly stretched between the pair of front and rear conveyor pulleys,
a plurality of conveying members, each having left and right end portions attached to outer surfaces, facing upward, of the left and right conveyor belts, respectively, configured to convey the coin rearwards in a manner laid flat and convey a coin, which has been discriminated by the discriminator as a counterfeit coin, frontwards in a manner laid flat as the conveyor belts are moved; and
a pair of left and right guide members, provided on left and right sides of the left and right conveyor belts, respectively, configured to prevent the conveying members from being separated from the conveyor belts.

2. The coin validation apparatus according to claim 1, wherein the conveying members each has a surface having a V-shape when viewed from upside as a surface for pressing the coin conveyed as the conveyor belts are moved.

3. The coin validation apparatus according to claim 1, wherein each of the conveying members has left and right end portions where curved surfaces are formed, the curved surfaces being opposite to surfaces which are in contact with outer surfaces, facing upward, of the pair of left and right conveyer belts, and the curved surfaces protrude upward.

4. The coin validation apparatus according to claim 1, wherein the pair of left and right guide members has left and right cutout portions having left and right cutouts, respectively, the left and right cutouts can be closed with left and right closing members, so that, when the cutouts are not closed by the closing members, the conveying members can be removed from the conveyor belts, and when the cutouts are closed by the closing members, the conveying members are prevented from being removed from the conveyor belts.

5. A coin validation apparatus comprising:
a conveyor configured to convey a coin; and
a discriminator, provided above the conveyor, configured to discriminate an authenticity and a denomination of the coin conveyed by the conveyor, wherein
the conveyor includes:
a pair of front and rear conveyor pulleys provided on front and rear sides of the coin validation apparatus,
a pair of left and right conveyor belts each endlessly stretched between the pair of front and rear conveyor pulleys,
a plurality of conveying members, each having a pair of left and right end portions attached to outer surfaces, facing upward, of the pair of left and right conveyor belts, respectively, configured to convey the coin rearwards in a manner laid flat and convey a coin, which has been discriminated by the discriminator as a counterfeit coin, frontwards in a manner laid flat as the conveyor belts are moved; and
the coin validation apparatus further comprises:
a passage detector configured to detect a passage of the coin and each of the conveying members passing an area where the discriminator discriminates; and
a controller configured to, upon receiving a command for stopping the conveyor belts, stop displacing the conveyor belts after the passage detector detects any of the conveying members.
